(19) United States
(12) Patent Application Publication
(10) Pub. No.: US 2015/0308153 A1
(43) Pub. Date: Oct. 29, 2015

(54) Lock Illuminating Device

(71) Applicant: Sandino Guarascio, Fort Mohave, AZ (US)

(72) Inventor: Sandino Guarascio, Fort Mohave, AZ (US)

(21) Appl. No.: 14/259,707

(22) Filed: Apr. 23, 2014

(51) Int. Cl. E05B 17/10; F21V 23/04; F21S 9/02; F21V 33/00

(52) U.S. Cl. CPC E05B 17/10; F21V 33/006; F21V 23/04; F21S 9/02

(57) ABSTRACT

A lock illuminating device couples to a surface proximate a key slot of a lock to illuminate the key slot facilitating operation of the lock in low light conditions. The device includes a housing having a front face, a rear face, and a perimeter wall extending between and around the front face and the rear face. A light and a dome cover are coupled to the housing. The dome cover extends over the light and has an opaque section directing illumination from the light in a direction away from the opaque section. A fastener is coupled to the housing for coupling to a surface proximate a lock. Thus, the housing is positionable to direct illumination towards a key slot of the a lock.

### BACKGROUND OF THE DISCLOSURE

### Field of the Disclosure

The disclosure relates to illuminating devices and more particularly pertains to a new illuminating device for coupling to a surface proximate a key slot of a lock to illuminate the key slot facilitating operation of the lock in low light conditions.

### SUMMARY OF THE DISCLOSURE

An embodiment of the disclosure meets the needs presented above by generally comprising a housing having a front face, a rear face, and a perimeter wall extending between and around the front face and the rear face. A light and a dome cover are coupled to the housing. The dome cover extends over the light and has an opaque section directing illumination from the light in a direction away from the opaque section. A fastener is coupled to the housing for coupling to a surface proximate a lock. Thus, the housing is positionable to direct illumination towards a key slot of the a lock.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top front side perspective view of a lock illuminating device according to an embodiment of the disclosure.

FIG. 2 is a side view of an embodiment of the disclosure.

FIG. 3 is a top view of an embodiment of the disclosure.

FIG. 4 is a front view of an embodiment of the disclosure.

FIG. 5 is a top front side view of an embodiment of the disclosure in use.

### DESCRIPTION OF THE PREFERRED EMBODIMENT

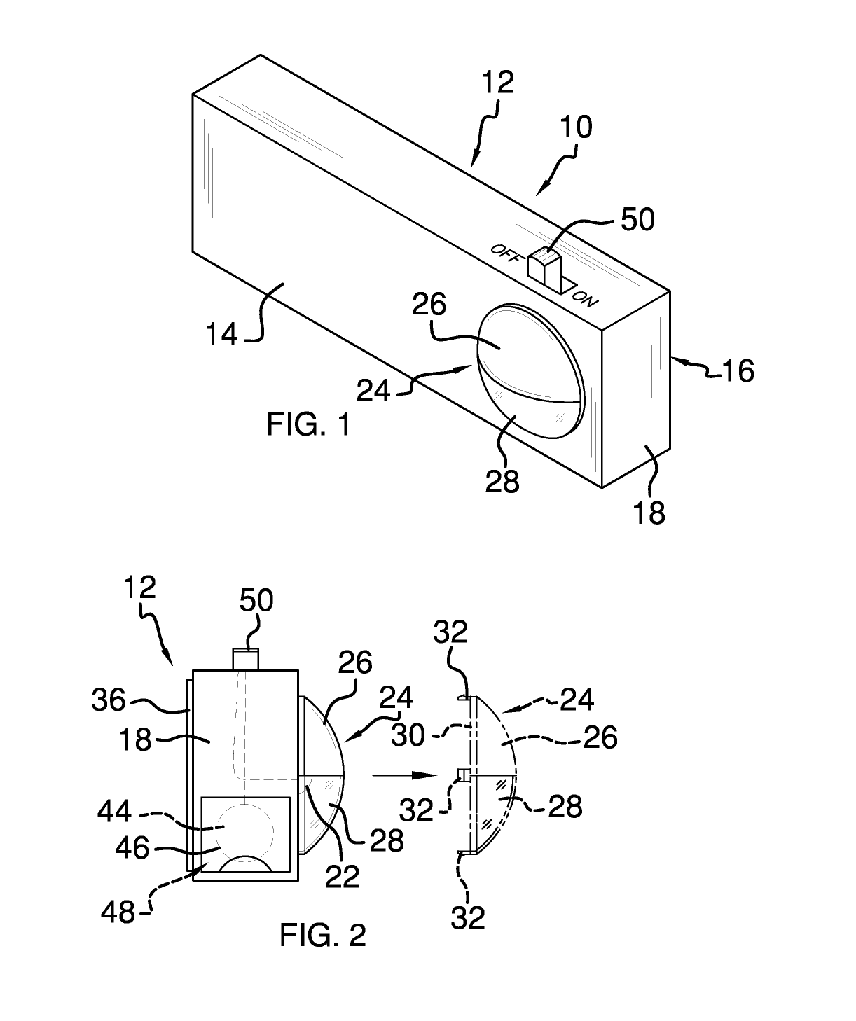

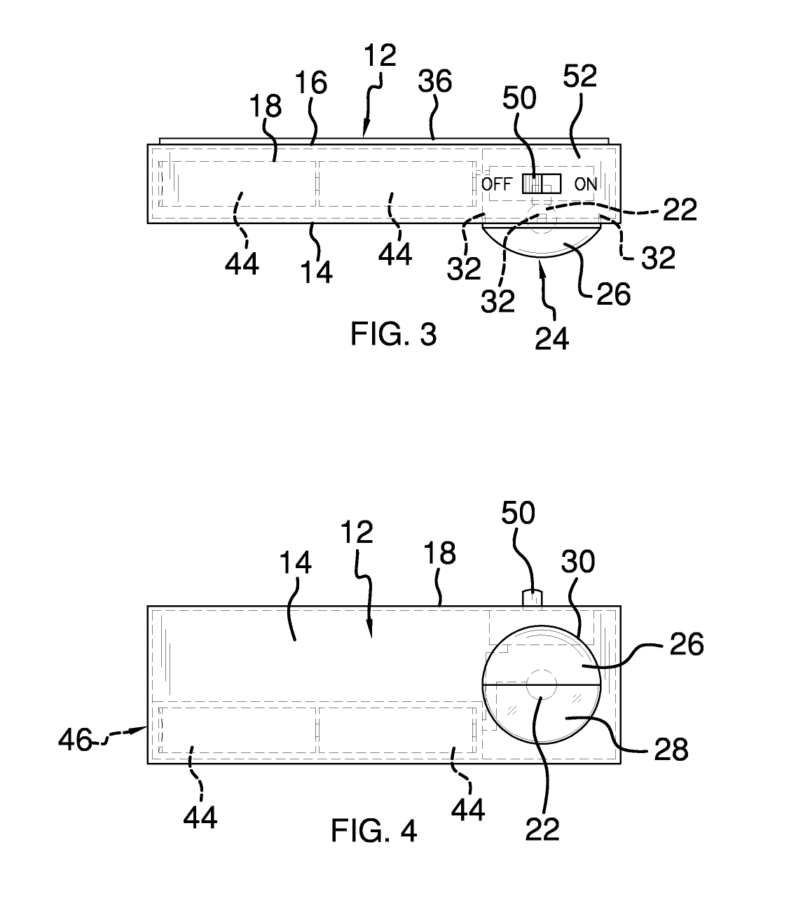

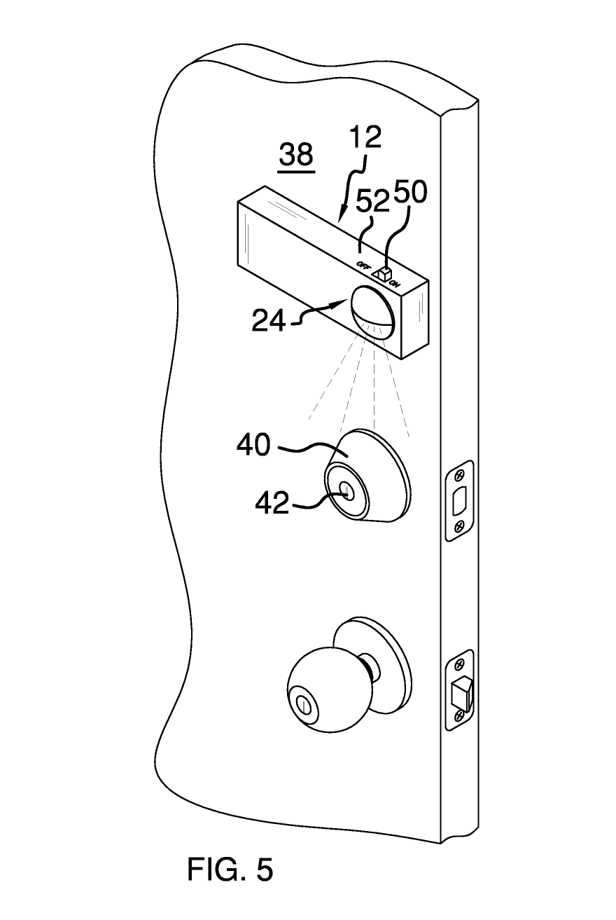

With reference now to the drawings, and in particular to FIGS. 1 through 5 thereof, a new illuminating device embodying the principles and concepts of an embodiment of the disclosure and generally designated by the reference numeral 10 will be described.

As best illustrated in FIGS. 1 through 5, the lock illuminating device 10 generally comprises a housing 12 having a front face 14, a rear face 16, and a perimeter wall 18 extending between and around the front face 14 and the rear face 16. The housing 12 defines and encloses an interior space 20. A light 22 is coupled to the housing 12. A dome cover 24 is coupled to the housing 12. The dome cover 24 extends over the light 22. The dome cover 24 is positioned on the front face 14 of the housing 12. The dome cover 24 has an opaque section 26 wherein the dome cover 24 directs illumination from the light 22 in a direction away from the opaque section 26. The opaque section 26 extends over half of the dome cover 24. The dome cover 24 comprises a frosted section 28 adjacent to and opposite the opaque section 26. The frosted section 28 is translucent for transmitting illumination through the dome cover 24 away from the opaque section 26. Alternatively, the dome cover 24 may be fully transparent, translucent, or a patterned combination of opaque, transparent, and translucent to provide no alteration of dispersed illumination or dispersal in a desired pattern.

The dome cover 24 has a circular outer perimeter 30. Each of a plurality of tabs 32 is coupled to and extends from the outer perimeter 30 of the dome cover 24. The tabs 30 couple the dome cover 24 to the housing 12. The tabs 32 are radially and evenly spaced around the outer perimeter 30 of the dome cover 24 wherein the dome cover 24 is detachable and couplable to the housing 12 for positioning the opaque section 26 of the dome cover 24 in a selectable position relative to the housing 12. Thus, illumination may be selectively directed in a desired direction outwardly from the housing 12.

A fastener 36 is coupled to the housing 12 wherein the housing 12 is configured for coupling to a surface 38 proximate a lock 40 wherein the housing 12 is positionable to direct illumination towards a key slot 42 of the lock 40 proximate the surface 38. The fastener 36 may be adhesive, screws, bolts, magnets, or the like. Alternatively, the housing 12 may be integrally incorporated into a door.

A battery 44 is coupled to the housing 12 and enclosed in the interior space 20. The battery 44 is electrically coupled to the light 22 wherein the light 22 is illuminated by the battery 44. The light 22 may be powered solely by the battery 44 to provide an independent unit positionable in any desired location without having to rely on an extrinsic power source for the light 22. The battery 44 may be replaced through use of a compartment door 46 covering an access opening 48 into the housing 12. A switch 50 is coupled to the housing 12. The switch 50 is positioned on a top side 52 of the perimeter wall 18 of the housing 12. The switch 50 is electrically coupled between the battery 44 and the light 22 wherein the light 22 is selectively illuminated by manipulation of the switch 50. The switch 50 extends outwardly from the housing 12 wherein the switch 50 is configured for facilitating tactile identification of and manipulation of the switch 50 on the housing 12.

In use, the housing 12 is coupled to the surface 38 proximate the lock 40. The dome cover 24 is coupled to the housing 12 in a desired orientation to direct illumination from the light 22 towards the lock 40. In low light conditions, the switch 50 may be manipulated resulting in illumination of the key slot 42 of the lock 40.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A lock illuminating device comprising:
a housing having a front face, a rear face, and a perimeter wall extending between and around said front face and said rear face;
a light coupled to said housing;
a dome cover coupled to said housing, said dome cover extending over said light, said dome cover having an opaque section wherein said dome cover directs illumination from said light in a direction away from said opaque section; and
a fastener coupled to said housing wherein said housing is configured for coupling to a surface proximate a lock wherein said housing is positionable to direct illumination towards a key slot of a lock proximate the surface.

2. The device of claim 1, further comprising:
said housing defining and enclosing an interior space;
a battery coupled to said housing and enclosed in said interior space, said battery being electrically coupled to said light wherein said light is illuminated by said battery.

3. The device of claim 2, further comprising said light being powered solely by said battery.

4. The device of claim 2, further comprising a switch coupled to said housing, said switch being electrically coupled between said battery and said light wherein said light is selectively illuminated by manipulation of said switch.

5. The device of claim 4, further comprising said switch extending outwardly from said housing wherein said switch is configured for facilitating tactile identification of and manipulation of said switch on said housing.

6. The device of claim 1, further comprising said opaque section extending over half of said dome cover.

7. The device of claim 1, further comprising said dome cover comprising a frosted section adjacent to said opaque section, said frosted section being translucent for transmitting illumination through said dome cover away from said opaque section.

8. The device of claim 1, further comprising said dome cover having a circular outer perimeter.

9. The device of claim 8, further comprising a plurality of tabs coupled to and extending from said outer perimeter of said dome cover, said tabs coupling said dome cover to said housing.

10. The device of claim 9, further comprising said tabs being radially and evenly spaced around said outer perimeter of said dome cover wherein said dome cover is detachable and couplable to said housing for positioning said opaque section of said dome cover in a selectable position relative to said housing.

11. The device of claim 1, further comprising said dome cover being positioned on said front face of said housing.

12. The device of claim 4, further comprising said switch being positioned on a top side of said perimeter wall of said housing.

13. A lock illuminating device comprising:
a housing having a front face, a rear face, and a perimeter wall extending between and around said front face and said rear face, said housing defining and enclosing an interior space;
a light coupled to said housing;
a dome cover coupled to said housing, said dome cover extending over said light, said dome cover being positioned on said front face of said housing, said dome cover having an opaque section wherein said dome cover directs illumination from said light in a direction away from said opaque section, said opaque section extending over half of said dome cover, said dome cover comprising a frosted section adjacent to said opaque section, said frosted section being translucent for transmitting illumination through said dome cover away from said opaque section, said dome cover having a circular outer perimeter;
a plurality of tabs coupled to and extending from said outer perimeter of said dome cover, said tabs coupling said dome cover to said housing, said tabs being radially and evenly spaced around said outer perimeter of said dome cover wherein said dome cover is detachable and couplable to said housing for positioning said opaque section of said dome cover in a selectable position relative to said housing;
a fastener coupled to said housing wherein said housing is configured for coupling to a surface proximate a lock wherein said housing is positionable to direct illumination towards a key slot of a lock proximate the surface;
a battery coupled to said housing and enclosed in said interior space, said battery being electrically coupled to said light wherein said light is illuminated by said battery, said light being powered solely by said battery; and
a switch coupled to said housing, said switch being positioned on a top side of said perimeter wall of said housing, said switch being electrically coupled between said battery and said light wherein said light is selectively illuminated by manipulation of said switch, said switch extending outwardly from said housing wherein said switch is configured for facilitating tactile identification of and manipulation of said switch on said housing.
